(19) United States
(12) Patent Application Publication
(10) Pub. No.: US 2014/0131538 A1
(43) Pub. Date: May 15, 2014

(54) Docking Station

(71) Applicant: INNUEVO, LLC, Washington, DC (US)

(72) Inventors: Michael Lewis Marshall, Washington, DC (US); Yenny Paola Moya, Silver Spring, MD (US)

(73) Assignee: INNUEVO, LLC, Washington, DC (US)

(21) Appl. No.: 13/795,762

(22) Filed: Mar. 12, 2013

Related U.S. Application Data
(60) Provisional application No. 61/725,991, filed on Nov. 13, 2012.

(51) Int. Cl. F16M 13/00

(52) U.S. Cl. CPC F16M 13/00
USPC 248/316.1; 248/309.1

(57) ABSTRACT

A docking station for an oblong-shaped device is provided. The docking station can include a mounting case and a mounting bracket assembly arranged on the mounting case. The mounting bracket assembly can be configured such that the oblong-shaped device is securable to the mounting case in both a landscape mode and a portrait mode. The mounting bracket assembly can include a base mounting bracket and at least one slidable mounting latch. The at least one slidable mounting latch can be arranged to slide over the oblong-shaped device in both the landscape mode and the portrait mode.

### CROSS REFERENCE TO RELATED APPLICATION

The present application claims the benefit from earlier filed U.S. Provisional Patent Application No. 61/725,991 filed Nov. 13, 2012, which is incorporated herein in its entirety by reference.

### FIELD OF THE INVENTION

The present teachings relate to a holder for a media device. In particular, the present teachings relate to a docking station holder for a media device and a keyboard. The docking station provides user-adjustable positioning and support for the media device, as well as additional features for optimizing performance of the media device.

### BACKGROUND OF THE INVENTION

Currently known holders for media devices do not allow a user an extensive amount of positional flexibility when used in a laptop-style arrangement with a keyboard. For example, known holders allow the media device to be held in either one of a landscape mode or a portrait mode. Moreover, many known holders only permit the media device to be positioned at preset angled positions with respect to the keyboard and/or at a preset distance from the keyboard. By providing such a limited amount of positional adjustability, known holders prevent users from finding an optimal working position with a maximum amount of comfort thereby jeopardizing work efficiency.

At the same time, known holders for media devices lack built-in electronics, such as speakers and a backup battery, thereby limiting a user's enjoyment of the media device during use.

Accordingly, there exists a need for a holder for a media device that can be readily adjusted by a user so as to be supportable in both a landscape mode and a portrait mode. There also exists a need for such a holder to allow extended use and enjoyment of the features of the media device.

### SUMMARY OF THE INVENTION

The present teachings provide a holder for an oblong-shaped device. The holder can include a mounting case and a mounting bracket assembly arranged on the mounting case. The mounting bracket assembly can be configured such that the oblong-shaped device is securable to the mounting case in both a landscape mode and a portrait mode. The mounting bracket assembly can include a base mounting bracket and at least one slidable mounting latch. The at least one slidable mounting latch can be arranged to slide over the oblong-shaped device in both the landscape mode and the portrait mode.

The present teachings further provide a docking station including a bottom case including a keyboard receiving area and a top case including a mounting bracket assembly arranged to secure an oblong-shaped device. A slidable pivot mechanism can be arranged to pivotally connect the top case to the bottom case and can be configured to allow the top case to slide along the bottom case in a forward direction towards the keyboard receiving area and a backward direction away from the keyboard receiving area.

The present teachings still further describe a docking station for an oblong-shaped device including a bottom case, a top case, and a mounting bracket assembly arranged on the top case and configured such that the oblong-shaped device is removably securable to the top case in more than one position. A slidable pivot mechanism can be arranged to connect the top case to the bottom case. The bottom case can include a keyboard receiving area, a re-chargeable battery receiving area, and at least one speaker.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 shows a perspective view of a docking station according to the present teachings arranged in an open position;

FIG. 2 shows a front perspective view of the docking station of the present teachings with a media device being secured thereto in a landscape mode;

FIG. 3 shows a front perspective view of the docking station of the present teachings with a media device being secured thereto in a portrait mode;

FIG. 4 shows an exploded perspective view of a top case and a slidable pivot mechanism of the docking station of FIG. 1;

FIG. 5 shows an exploded perspective view of the bottom case of the docking station of FIG. 1;

FIG. 6 shows a side perspective view of the docking station with the top case slid backwards as far as possible from the keyboard;

FIG. 7 shows a side perspective view of the docking station with the top case slid forward towards the keyboard; and

FIG. 8 shows a side perspective view of the docking station with the top case being slid forward as close as possible to the keyboard.

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

The present teachings relate to a holder that is intended to be used with a media device but could be used with any substantially planar device that is to be supported in a position for convenient viewing by a user. The holder can be in the form of a docking station that can include an area for accepting the media device and an area for accepting a keyboard that is to be used with the media device. When the media device and keyboard are held in the docking station, the keyboard can be synced with the media device in a wired or wireless manner. The media device can be any substantially planar electronic device, such as a tablet PC, e-book reader, smartphone, or any other hardware device having a display. The substantially planar device can have an oblong shape.

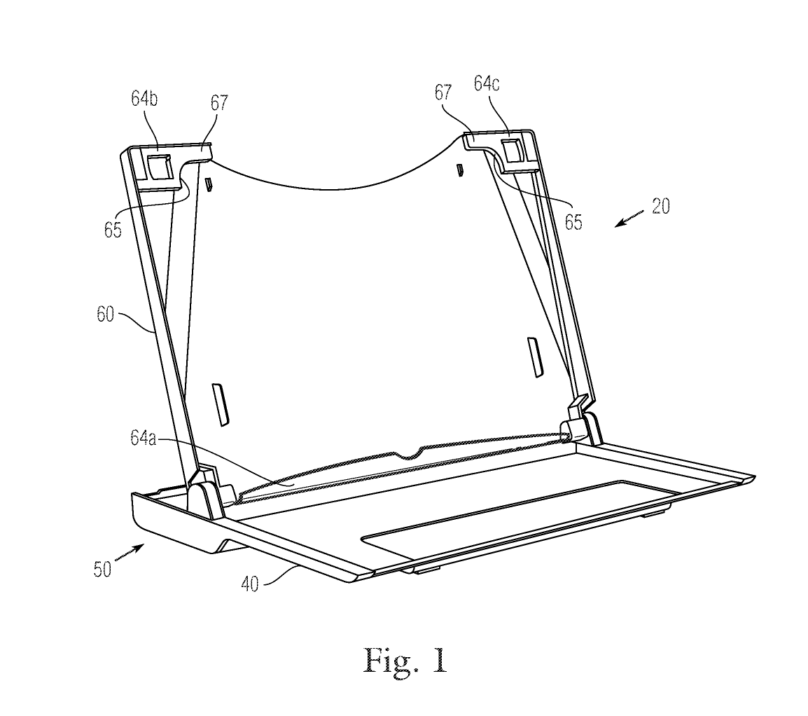

Referring to FIG. 1, the holder 20 of the present teachings can be a docking station including a bottom case 40 for a supporting a keyboard, a top case 60 for supporting the media device, and a slidable pivot mechanism 50. The slidable pivot mechanism 50 can provide a pivotable connection between the bottom case 40 and the top case 60. For example, the slidable pivot mechanism 50 can provide a hinged connection between the bottom case 40 and the top case 60. As will be described in more detail below, the slidable pivot mechanism 50 can also include a sliding mechanism that allows slidable adjustment between the top case 60 and the bottom case 40 by allowing the top case 60 to be slid forward and backward along the bottom case 40. The sliding mechanism thereby allows adjustment of the distance between a media device 100 (that can be secured to the top case 60) and a keyboard (that can be arranged in the bottom case 40).

In each of FIGS. 1-3, the docking station 20 is shown in an open position as it would be typically used. In such an open position, the top case 60 is arranged to extend substantially vertically (or beyond a substantially vertical position depending upon the comfort of the user) with respect to the bottom case 40. Moreover, the top case 60 can also be slidable towards and away from the user along the bottom case 40 in order to balance the top case 60 (and the secured media device 100) on the bottom case 40 and to provide a user-selectable position for comfortable use.

The top case 60 can include a mounting bracket assembly for supporting and securing a media device 100 to the top case 60. The mounting bracket assembly can include a plurality of mounting brackets or latches. For example, the plurality of mounting brackets can include a base mounting bracket 64a, a first upper mounting latch 64b, and a second upper mounting latch 64c. As will be described in more detail below, each of the first upper mounting latch 64b and the second upper mounting latch 64c can be arranged to be displaceable so as to releasably secure and hold the media device 100 to the top case 60.

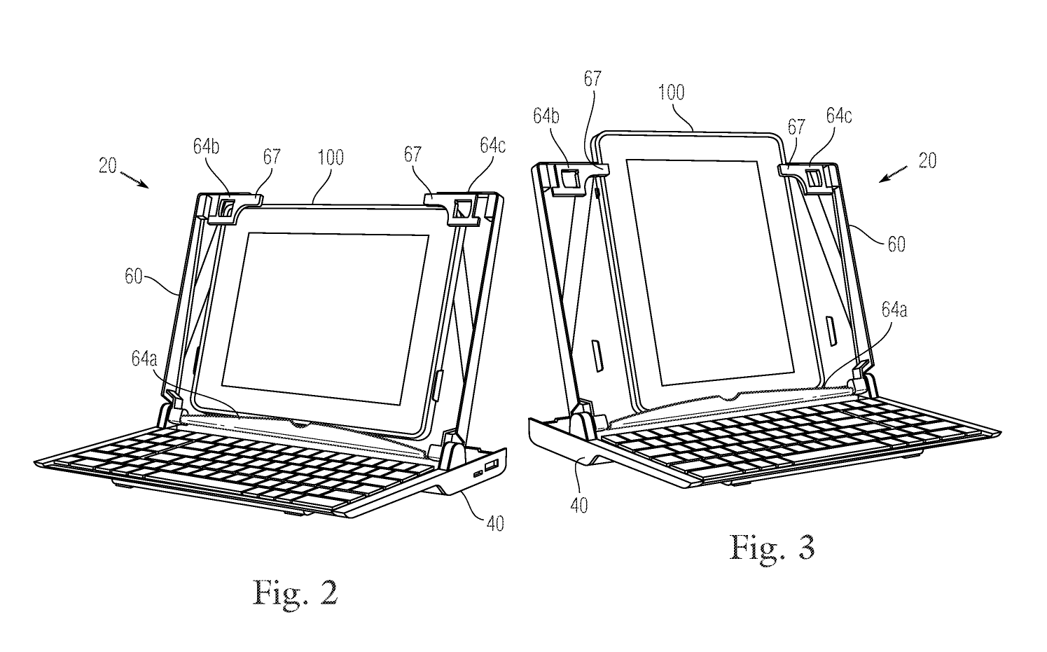

The base mounting bracket 64a and the first and second upper mounting latches 64b, 64c can be arranged on the top case 60 so as to support and secure an oblong-shaped device 100 both horizontally as shown in FIG. 2 (i.e. in a landscape mode) and vertically as shown in FIG. 3 (i.e. in a portrait mode). More particularly, the mounting brackets and/or latches can be configured such that an oblong-shaped device 100 is supportable on the top case 60 in both (i) a first position where a longitudinal axis of the oblong-shaped device 100 extends substantially horizontally, and (ii) a second position where the longitudinal axis of the oblong-shaped device extends substantially vertically, while the top case 60 is kept stationary and in a substantially upright position.

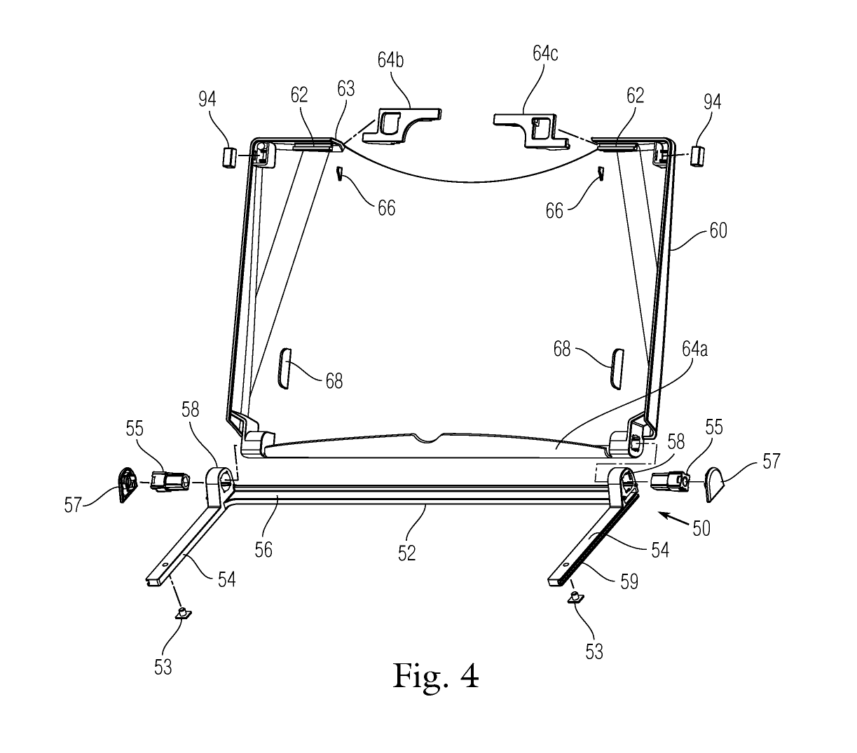

As shown in FIG. 4, the base mounting bracket 64a forms a receiving groove or holder defined by a projecting member that can extend outwardly from a surface of the top case 60 and a further upstanding lip that can extend generally upwardly from the projecting member. However, the receiving groove formed by the base mounting bracket 64a can take on other shapes, such as a continuously curved receiving groove, or any other shape that operates to extend from the top case 60 and act as a support area for holding a bottom surface of the media device 100. The groove formed by the base mounting bracket 64a can be sized so as to snuggly support the media device 100 against the top case 60. The base mounting bracket 64a can be used to support the weight of the media device 100 notwithstanding which position (landscape or portrait) the media device 100 is being held.

The base mounting bracket 64a can be arranged to extend substantially horizontally along a bottom portion of the top case 60. The base mounting bracket 64a can be non-adjustably arranged on the top case 60. While a single base mounting bracket 64a is shown, the base mounting bracket 64a can be formed by two or more brackets that are sequentially arranged along the bottom of the top case 60. For example, the base mounting bracket 64a can take the form of a plurality of flanged studs extending along a bottom portion of the top case 60.

The upper mounting latches 64b, 64c can be arranged along a top portion of the top case 60 and can operate to releasably secure a top portion of the media device 100 to the top case 60. One or more of the upper mounting latches 64b, 64c can be arranged to be displaceable or slidable between an open position where a media device 100 is allowed to be inserted into the top case 60 and a closed position which secures the media device 100 to the top case 100.

For example, the slideable mounting latches 64b, 64c can be moved laterally outwardly to the open position as shown in FIG. 1. In this open position, a bottom surface of the media device 100 can be inserted into the middle portion of the groove forming the base mounting bracket 64a in either a landscape mode or a portrait mode. The media device 100 can then be pushed up against the top case 60 without interference from either of the upper mounting latches 64b, 64c.

As best shown in FIG. 1, the shape of the upper mounting latches 64b, 64c allows the media device 100 to be inserted against the top case 60 without any structural interference, yet allows the upper mounting latches 64b, 64c to be in close proximity to the installed media device 100 so that the upper mounting latches 64b, 64c only need to be moved a small distance to secure the media device 100 to the top case 60. In this regard, the upper mounting latches 64b, 64c can define curved cut-out portions 65 to allow insertion of the media device 100 in a landscape mode as well as elongated fingers 67 that can be moved to extend over the media device 100 after insertion in either the landscape mode or the portrait mode. However, the upper mounting latches 64b, 64c can take other shapes as would be appreciated by one of ordinary skill in the art.

After the media device 100 is inserted into the base mounting bracket 64a and placed up against the top case 60, the upper mounting latches 64b, 64c can be moved inwardly to a closed position whereby a portion of the mounting latches 64b, 64c extend over the media device 100 and prevent the media device 100 from falling out of engagement with the top case 60 during use.

FIG. 2 shows a closed position of the latches 64b, 64c with the media device 100 arranged in a landscape mode, while FIG. 3 shows a closed position of the latches 64b, 64c with the media device 100 arranged in a portrait mode. As shown in FIG. 2, a base portion and an elongated finger 67 of each of the upper mounting latches 64b, 64c can extend over the media device 100 when installed in the landscape mode. As shown in FIG. 3, a finger part 67 of each of the upper mounting latches 64b, 64c can extend over the media device 100 when installed in the portrait mode.

Referring to FIG. 4, an exemplary embodiment of the slidable connection between the upper mounting latches 64b, 64c and the top case 60 is shown. According to this preferred embodiment, the slidable connection can include one or more rails 62 extending from a top surface of the top case 60. Moreover, the upper mounting latches 64b, 64c can be formed with slots that are sized and shaped to receive and slide on the rails 62. This rail and slot arrangement allows the upper mounting latches 64b, 64c to be moved and guided laterally between the open and closed positions with respect to the top case 60. In addition, structure can be provided to act as a stop so that each latch 64b, 64c can be prevented from moving too far and disconnecting from a rail 62 during inward or outward movement thereof. Other slidable connections could be implemented to allow controlled latch movement between the open and closed positions as would be appreciated by one of ordinary skill in the art.

The top surface of the top case 60 can also be provided with a cut-out portion 63. The cut-out portion 63 provides an area where a top portion of the media device 100 can extend from when installed in the portrait mode. The cut-out portion 63 can also be a guide to help the user install the media device 100 in the center of the top case 60. Furthermore, the top case 60 can be provided with flanges 66 to ensure proper positioning of the media device 100 in the portrait mode. Similarly, the top case 60 can be provided with a further set of flanges 68 to ensure proper positioning of the media device 100 in the landscape mode.

Still referring to FIG. 4, the slidable pivot mechanism 50 is shown in an exploded view along with the top case 60. The slidable pivot mechanism 50 can include a hinge slide 52 which can be arranged to provide a pivotable connection to the top case 60 as well as a slidable connection with respect to bottom case 40. The hinge slide 52 can include two rails 54, a base member 56 that extends laterally between the rails 54, and two bearing housings 58. The rails 54, base member 56, and bearing housings 58 of the hinge slide 52 can be formed as a one-piece, unitary structure. The pivotable connection between the top case 60 and the hinge slide 52 can be achieved via torque nuts 55. A torque nut 55 can be arranged to extend through an aperture formed in a respective bearing housing 58 of the hinge slide 52 and into a bore formed in the top case 60. For aesthetic purposes, a hinge cap 57 can be placed over the installed torque nut 55.

The hinge slide 52 allows the top case 60 to pivot with respect to the bottom case 30 from a closed position where the top case 60 is in contact with the bottom case 40 to an open position where the top case 60 forms an obtuse angle with the bottom case 40. For example, the hinge slide 80 can allow the top case 60 to pivot through an arc of about 140° with respect to the bottom case 30. The hinge slide 52 and torque nuts 55 allow the user to pivot the top case 60 to any angular position and to have that angular position held.

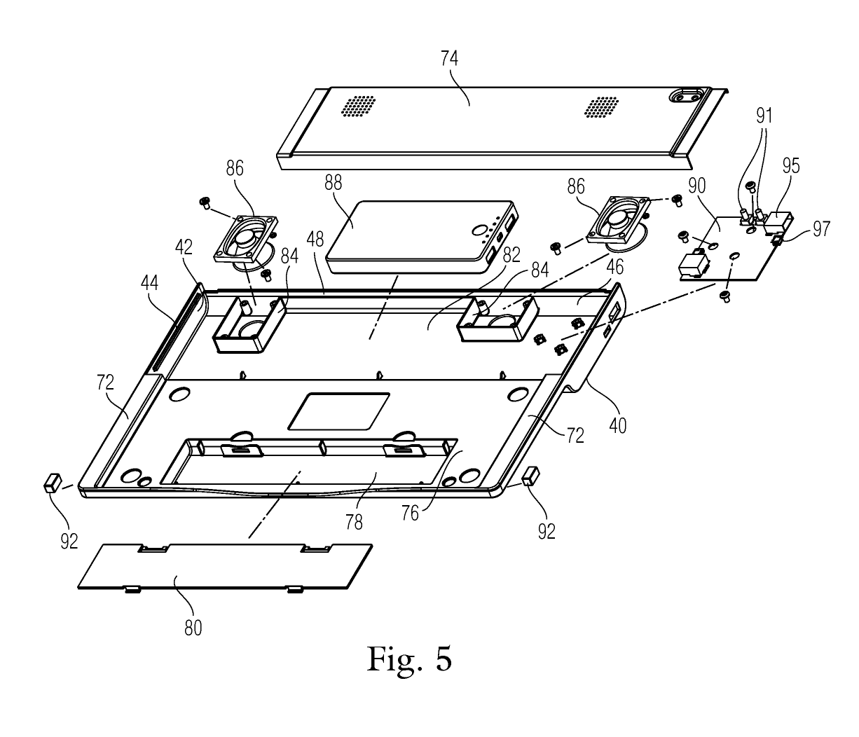

The hinge slide 52 also allows the top case 60 to slide with respect to bottom case 40. As set forth above, the hinge slide 52 can include two rails 54 that extend perpendicularly with respect to the base member 56. The rails 54 can be arranged to slide within the bottom case 40 to allow the pivotably attached top case 60 to slide with respect to the bottom case 40. In particular, each of the rails 54 can be arranged to slide within complimentary-shaped elongated passages 72 formed in the bottom case 40. FIG. 5 shows the elongated passages 72 located on either side of a keyboard receiving area 76 of the bottom case 40. As shown in FIG. 4, each of the rails 54 can be provided with hinge nuts 53 to act as stops to limit movement of the hinge slide 52 with respect to the bottom case 40.

To help guide the movement of the rails 54 of the hinge slide 52 within the elongated passages 72 of the bottom case 40, each inner side wall 42 of the bottom case 40 can include guide rails 44 that can engage with guide slots 59 formed on the exterior of the rails 54. Each of the guide rails 44 can be arranged on the upper portion of the inner side walls 42. As such, the hinge slide 52 (including the base member 56) can be guided to slide over a battery cover 74 in its installed position on the bottom case 40. When installed, the battery cover 74 can be arranged substantially flush with a keyboard receiving area 76 of the bottom case 40. Moreover, a back wall 46 of the bottom case 40 can include an upwardly extending lip 48 to act as a stop for the base member 56 of the hinge slide 52. Further details of the structure of the bottom case 40 will be provided below.

The sliding rail mechanism 50 of the present teachings thereby allows the top case 60 to be moved forward and backward along the bottom case 40 to allow adjustment of the distance between the top case 60 and the bottom case 40, and in turn, the distance between the media device 100 and keyboard supported in the keyboard receiving area 76.

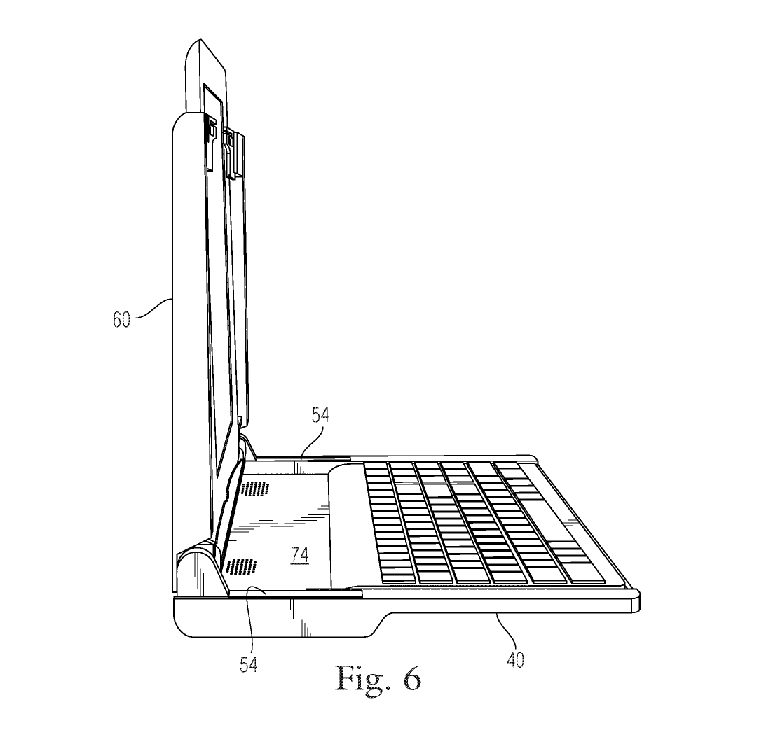

Referring to FIGS. 6-8, the pivoting and forward/backward sliding movement of the top case 60 with respect to the bottom case 40 is illustrated.

FIG. 6 shows the top case 60 arranged substantially perpendicularly with respect to the bottom case 40, with the top case 60 arranged a relatively far distance from the keyboard. In this position, the rails 54 of the hinge slide 52 are slide back as far as possible within their respective elongated passages 72 such that the base member 56 of the hinge slide 52 abuts against the upwardly extending lip 48 of the back wall 46 of the bottom case 40.

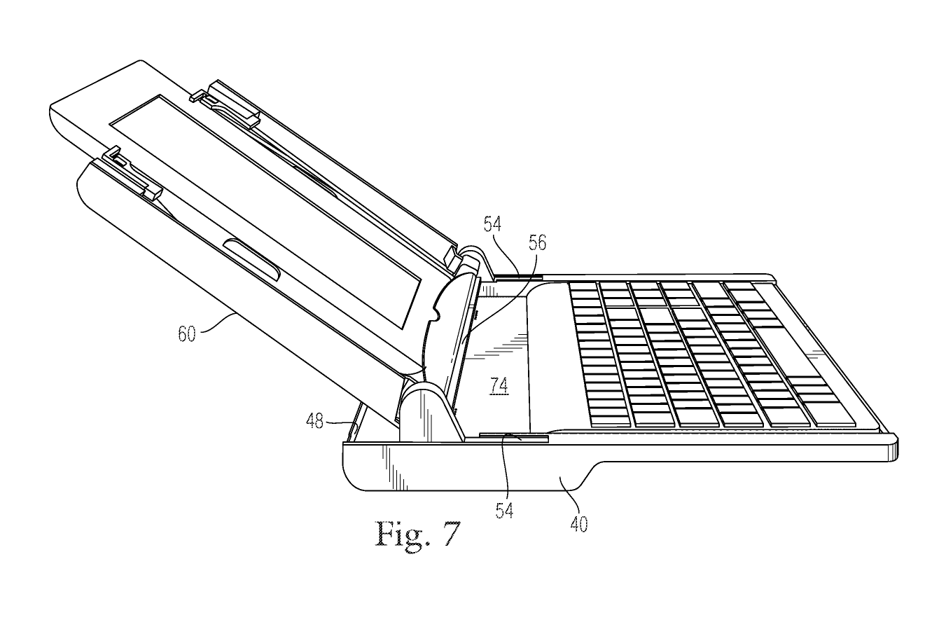

FIG. 7 shows the top case 60 pivoted further with respect to the bottom case 40, and the top case 60 being slid forward a distance towards the keyboard (and the user). In this position, the rails 54 of the hinge slide 52 have been slid a distance into their respective elongated passages 72. Moreover, the laterally extending base member 56 of the hinge slide 52 has also slid across the top of the battery cover 74 of the bottom case 40.

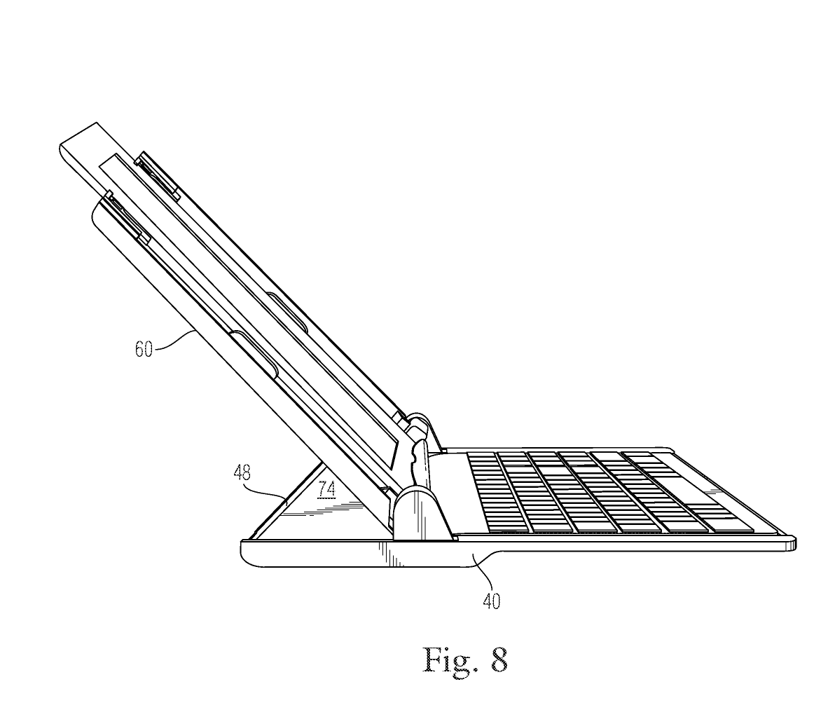

FIG. 8 shows the top case 60 being slid forward as far as possible towards the keyboard. In this position, the rails 54 of the hinge slide 52 have been slid substantially entirely into their respective elongated passages 72.

Referring back to FIG. 5, the design of the bottom case 40 will be described in detail. For example, the bottom case 40 can include a storage compartment 78 for cables and other accessories. The storage compartment 78 can include a cover 80 that can snap into the bottom case 40 to allow ready access to the contents of the storage compartment 78. The front portion of the bottom case 40 defines a keyboard receiving area 76. The keyboard receiving area 76 can be situated between the elongated passages 72 formed on the sides of the bottom case 40. When the cover 80 for the storage compartment 78 is attached to the bottom case 40, the cover 80 and the keyboard receiving area 76 can form a substantially flush surface.

Behind the keyboard receiving area 76 (in the back portion of the bottom case 40), a recessed area 82 can be provided which can house various additional features. For example, the recessed area 82 can include one or more speaker housings 84. One or more speakers 86 can be arranged in each speaker housing 84. The recessed area 82 of the bottom case 40 can also include an area for securing a backup battery 88. The backup battery 88 can be, for example, a rechargeable, lithium ion battery, or any other type of battery as would be appreciated by one of ordinary skill in the art. The recessed area 82 can also house a circuit board 90 including a plurality of external ports. Some of external ports can be arranged to be connected to the backup battery 88. The external ports can include at least one USB port 95 and at least one micro USB port 97. The circuit board 90 can also include additional ports, such as, for example, an audio jack. The circuit board 90 can include one or more user-actuated buttons 91. For example, a user-actuated button 91 can be arranged to control the syncing between the one or more speakers 86 and the media device 100. For another example, a user-actuated button 91 can be arranged to turn on the backup battery 88.

A battery cover 74 can be arranged to be situated over the recessed area 82 of the bottom case 40. The battery cover 74 can be used to cover and protect the backup battery 88, the speakers 86, the circuit board 90, and other components housed in the bottom case 40. When attached to the bottom case 40, the battery cover 74 and the keyboard receiving area 76 can be arranged to provide an area into which a keyboard can be inserted. The keyboard receiving area 76 is arranged so that a keyboard can be securely supported thereon and held by other structure of the bottom case 40 so as to be substantially immobilized as keys are being clicked on the keyboard by a user.

As also shown in FIG. 5, the bottom case 40 can include one or more magnets 92 arranged on the bottom case 40. In particular, the one or more magnets 92 can be arranged at the outer corners of the bottom case 40. One or more magnets 94 can also be formed at corresponding locations on the top case 60. For example, as shown in FIG. 4, one or more magnets 94 can be formed at the outer corners of the top case 60.

When the user desires to simultaneously carry the media device 100 and a keyboard during travel, the top case 60 is pivoted with respect to the bottom case 40. As the top case 60 approaches the bottom case 40, the first magnets 92 of the bottom case 40 and the second magnets 94 of the top case 60 are magnetically attracted by each other. Consequently, the top case 60 is closed to cover the bottom case 40. In this situation, the docking station can act as a protective carrying case for the media device and keyboard.

The holder 20 of the present teachings can be made various materials, such as, for example, plastic, metal, or combinations thereof. Materials that can be used include stainless steel, aluminum (brushed aluminum), polymers, composites, and the like. For parts made from plastic, they can be made by an injection-molding process. In a preferred embodiment, the holder 20 can be made from injection-molded, polycarbonate plastic. Moreover, one or more portions of the holder 20 of the present teachings can be made from recycled materials.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A holder for an oblong-shaped device comprising:
a mounting case; and
a mounting bracket assembly arranged on the mounting case;
wherein the mounting bracket assembly is configured such that the oblong-shaped device is securable to the mounting case in both a landscape mode and a portrait mode; and
wherein the mounting bracket assembly includes a base mounting bracket and at least one slidable mounting latch, the at least one slidable mounting latch being arranged to slide over the oblong-shaped device in both the landscape mode and the portrait mode.

2. The holder of claim 1, wherein the at least one slidable mounting latch is movable along a latch guide arranged on the mounting case.

3. The holder of claim 1, wherein the at least one slidable mounting latch includes a cut-out portion shaped to allow insertion of the oblong-shaped device onto the mounting case in the landscape mode when the mounting latch is in a retracted position.

4. The holder of claim 1, further comprising a bottom case attached to the mounting case by way of a slidable pivot mechanism that is configured to allow the top mounting case to pivot with respect to the bottom case and allow the mounting case to slide along the bottom case in a forward direction and a backward direction.

5. The holder of claim 4, wherein the bottom case includes a keyboard receiving area.

6. The holder of claim 4, wherein the slidable pivot mechanism includes a hinge slide having at least one rail that is arranged to slide on the bottom case.

7. The holder of claim 6, wherein the at least one rail is slidable along at least one elongated passage formed in the bottom case.

8. The holder of claim 4, wherein the slidable pivot mechanism is arranged to allow the mounting case to slide over a battery compartment formed in the bottom case.

9. A docking station comprising:
a bottom case including a keyboard receiving area;
a top case including a mounting bracket assembly arranged to secure an oblong-shaped device; and
a slidable pivot mechanism arranged to pivotally connect the top case to the bottom case and configured to allow the top case to slide along the bottom case in a forward direction towards the keyboard receiving area and a backward direction away from the keyboard receiving area.

10. The docking station of claim 9, wherein the mounting bracket assembly is configured such that an oblong-shaped device is securable to the mounting tray in both a landscape mode and a portrait mode.

11. The docking station of claim 10, wherein the mounting bracket assembly includes at least one slidable mounting latch that is displaceable so as to be capable of securing the oblong-shaped device to the mounting case in both the landscape mode and the portrait mode.

12. The docking station of claim 11, wherein the at least one slidable mounting latch includes a cut-out portion shaped to allow insertion of the oblong-shaped device onto the top case in the landscape mode when the mounting latch is in a retracted position.

13. The docking station of claim 11, wherein the at least one slidable mounting latch is movable along a latch guide rail arranged on the top case.

14. The docking station of claim 10, wherein the mounting bracket assembly includes a base mounting bracket and at least one slidable mounting latch, the at least one slidable mounting latch being displaceable so as to be capable of securing the oblong-shaped device to the mounting case in both the landscape mode and the portrait mode.

15. The docking station of claim 9, wherein the slidable pivot mechanism includes at least one rail arranged to be slidable on the bottom case to allow the top case to slide on the bottom case in the forward direction and the backward direction.

16. The docking station of claim 15, wherein the at least one rail is slidable within at least one elongated passage formed in the bottom case.

17. The docking station of claim 9, wherein the slidable pivot mechanism is arranged to allow the top case to slide over a battery compartment formed in the bottom case.

18. A docking station for an oblong-shaped device comprising:
a bottom case;
a top case;
a mounting bracket assembly arranged on the top case and configured such that the oblong-shaped device is removably securable to the top case in more than one position; and
a slidable pivot mechanism arranged to connect the top case to the bottom case;
wherein the bottom case includes a keyboard receiving area, a re-chargeable battery receiving area, and at least one speaker.

19. The docking station of claim 18, wherein the mounting bracket assembly is configured such that the oblong-shaped device is securable to the mounting case in both a landscape mode and a portrait mode.

20. The docking station of claim 18, wherein the bottom case further includes at least one external port arranged to be connectable to the re-chargeable battery.

21. The docking station of claim 18, wherein the bottom case further includes at least one external port arranged to be connectable to the at least one speaker.

22. The docking station of claim 18, wherein the slidable pivot mechanism is configured to allow the top case to slide along the bottom case in a forward direction towards the keyboard receiving area and a backward direction away from the keyboard receiving area.
